(19) United States
(12) Patent Application Publication
(10) Pub. No.: US 2026/0028275 A1
(43) Pub. Date: Jan. 29, 2026

(54) METHOD FOR PRODUCING A GEOPOLYMER COMPOSITION AND METHOD FOR PRODUCING A GEOPOLYMER HARDENED BODY

(71) Applicant: TOKUYAMA CORPORATION, Yamaguchi (JP)

(72) Inventors: Takahiro ONISHI, Yamaguchi (JP); Kohei OMURA, Yamaguchi (JP)

(73) Assignee: TOKUYAMA CORPORATION, Yamaguchi (JP)

(21) Appl. No.: 19/111,060

(22) PCT Filed: Sep. 22, 2023
(86) PCT No.: PCT/JP2023/034547

§ 371 Date: Mar. 12, 2025

(30) Foreign Application Priority Data
Sep. 26, 2022 (JP) 2022-152817

(51) Int. Cl. C04B 12/00

(52) U.S. Cl. CPC C04B 12/005

(57) ABSTRACT

A method for producing a geopolymer composition that includes injecting carbon dioxide gas to a slurry containing slag fine powder and water so that the pH of the slurry becomes 6.0 to 12.0, to perform carbonation treatment to the slag fine powder, and mixing the slurry containing the slag fine powder which has been subjected to carbonation treatment with fly ash and alkali metal salt; or injecting carbon dioxide gas to a slurry containing slag fine powder, fly ash and water so that the pH of the slurry becomes 6.0 to 12.0, to perform carbonation treatment to the slag fine powder, and mixing the slurry containing the slag fine powder which has been subjected to carbonation treatment with alkali metal salt.

### TECHNICAL FIELD

The present invention relates to a technique for retarding setting of geopolymer.

### BACKGROUND ART

Geopolymer is defined as “hardened without using cement clinker, while using a raw material comprising amorphous aluminum silicate as main component (active filler), and at least one type of aqueous solution of silicate, carbonate, hydroxide of alkali metal (alkali source)”, and is getting attention as construction material since it has low CO₂ emission at the time of production, and being excellent in acid resistance, heat resistance, etc. as compared to cement hardened body.

Recently, slag fine powder is used in combination additionally to fly ash as active filler, aiming improvement of strength development of geopolymer under environment of ordinary temperature. However, by using slag fine powder as active filler, the working time (setting time) of geopolymer is as short as within about 15 to 40 min., and a big problem arises that sufficient time cannot be secured for transportation or placement.

Thus, in Patent Literature 1, a method for producing a geopolymer composition being superior in working time and initial strength, consisting of a step of obtaining a slag fine powder that has been subjected to carbonation treatment under an atmosphere of carbon dioxide concentration of 1% or more, and a step of mixing the slag fine powder that has been subjected to carbonation treatment with alkali source and fly ash, is disclosed.

### CITATION LIST

### Patent Literature

Patent Literature 1: Japanese Patent Laid-Open Publication No. 2021-54678

### SUMMARY OF INVENTION

### Technical Problem

The production method of geopolymer described in Patent Literature 1 is thought to be a method with a large environmental load, since carbonation treatment of slag fine powder is performed while maintaining high temperature and humidity for up to 30 days, and after performing the carbonation treatment, drying treatment is necessary, and thus the productivity is very low, and the energy consumption is large. From the above, no technique has been yet disclosed, with which the working time can be extended while maintaining strength development of the geopolymer, in a short time and simply, and which has a low burden on environment.

The present invention has been made based on such circumstances, and the object is to provide a method for producing a geopolymer composition having sufficient working time for operation, while maintaining strength development, in a short time and simply, and having a low burden on environment.

### Solution to Problem

The present inventors made a keen study to obtain a geopolymer composition having sufficient setting time for operation while maintaining strength development, in a short time and simply, and as a result, they found out that by providing a step of injecting carbon dioxide gas to slag fine powder and slurry, to perform carbonation treatment until reaching a certain pH, an effect of extending working time (setting time) of geopolymer can be obtained in a short time and simply, and without large burden on environment.

Specifically, the first embodiment of the present invention is a method for producing a geopolymer composition comprising slag fine powder, fly ash and alkali metal salt, the method comprising:
(1) a first step of injecting carbon dioxide gas to a slurry comprising slag fine powder and water so that the pH of the slurry becomes 6.0 to 12.0, to perform carbonation treatment to the slag fine powder, and a second step of mixing the slurry comprising the slag fine powder which has been subjected to carbonation treatment obtained by the first step, with fly ash and alkali metal salt; or
(2) a first step of injecting carbon dioxide gas to a slurry comprising slag fine powder, fly ash and water so that the pH of the slurry becomes 6.0 to 12.0, to perform carbonation treatment to the slag fine powder, and a second step of mixing the slurry comprising the slag fine powder which has been subjected to carbonation treatment obtained by the first step, with alkali metal salt.

It is preferable that the pH of the slurry in the first step is 6.5 to 7.5. Further, it is preferable to perform the treatment of the first step and second step, at a construction site where the geopolymer composition is hardened.

The second embodiment of the present invention is a method for producing a geopolymer hardened body, comprising after obtaining a geopolymer composition by to the above-mentioned method, curing the obtained geopolymer composition within a temperature range of 5° C. to 90° C. It is characterized to have high strength development at ordinary temperature (5° C. to 35° C.)

Meanwhile, it is preferable that the alkali metal salt comprises alkali silicate powder and alkali carbonate powder. It is more preferable that the alkali metal silicate powder is a sodium silicate powder, and it is more preferable that the alkali metal carbonate powder is a sodium carbonate powder. Further, it is preferable that the alkali metal silicate powder is a sodium silicate powder and the alkali metal carbonate powder is a sodium carbonate powder.

### Advantageous Effects of Invention

With a method for producing a geopolymer composition comprising a step of injecting carbon dioxide gas to a slurry comprising slag fine powder and water so to have a certain pH, to perform carbonation treatment to the slag fine powder, and using the slag fine powder that has been subjected to carbonation treatment as a slurry, a geopolymer composition having a working time (setting time) sufficient for construction, and having a high strength development can be obtained. Further, since the production method of the present invention can be practiced with conventional geopolymer materials and known knead mixing apparatus at a construction site, it has an advantage of being simple, and having low burden on environment.

### DESCRIPTION OF EMBODIMENTS

In the following the embodiments of the present invention will be explained in detail, while the present invention shall not be limited to these embodiments. Further, “part” or “%” herein mentioned refers to mass standard, unless otherwise defined.

### Method for Producing Geopolymer Composition

The method for producing a geopolymer composition of the present invention comprises a first step and a second step.

The present invention is a method for producing a geopolymer composition comprising a carbonated slag fine powder, fly ash and alkali metal salt, the method comprising:
(1) a first step of injecting carbon dioxide gas to a slurry comprising slag fine powder and water so that the pH of the slurry becomes 6.0 to 12.0, to perform carbonation treatment to the slag fine powder, and a second step of mixing the slurry comprising the slag fine powder which has been subjected to carbonation treatment obtained by the first step, with fly ash and alkali metal salt; or
(2) a first step of injecting carbon dioxide gas to a slurry comprising slag fine powder, fly ash and water so that the pH of the slurry becomes 6.0 to 12.0, to perform carbonation treatment to the slag fine powder, and a second step of mixing the slurry comprising the slag fine powder which has been subjected to carbonation treatment obtained by the first step, with alkali metal salt.

Hereinafter, the method for producing a geopolymer composition comprising (1) a first step of injecting carbon dioxide gas to a slurry comprising slag fine powder and water so that the pH of the slurry becomes 6.0 to 12.0, to perform carbonation treatment to the slag fine powder, and a second step of mixing the slurry comprising the slag fine powder which has been subjected to carbonation treatment obtained by the first step, with fly ash, and alkali metal salt, is referred to as production method (1); and the method for producing a geopolymer composition comprising (2) a first step of injecting carbon dioxide gas to a slurry comprising slag fine powder, fly ash and water so that the pH of the slurry becomes 6.0 to 12.0, to perform carbonation treatment to the slag fine powder, and a second step of mixing the slurry comprising the slag fine powder which has been subjected to carbonation treatment obtained by the first step, with alkali metal salt is referred to as production method (2).

The difference between production method (1) and production method (2) is the difference of whether mixing fly ash in the first step is an essential requirement, or mixing fly ash in the second step is an essential requirement. In the production method (1), it is essential to mix fly ash in the second step, and in the production method (2), it is essential to mix fly ash in the first step. In either production method, it does not prevent to mix fly ash in both steps, first step and second step. Specifically, in the production method (1), fly ash may be mixed in the first step additionally to the second step, and in the production method (2), fly ash may be mixed in the second step additionally to the first step.

First, the production method (1) is explained.

### First Step

In the first step of the production method (1), carbon dioxide gas is injected to a slurry comprising slag fine powder and water so that the pH of the slurry becomes 6.0 to 12.0, to perform carbonation treatment to the slag fine powder.

### Slag Fine Powder

Slag fine powder is formed at the same time as the generation of pig iron, and comprises CaO, SiO₂, Al₂O₃, MgO as main components. Examples of slag fine powder include, for example those comprising calcium at 20 mass % or more 60 mass % or less in calcium oxide (CaO) equivalent. Further, the types of slag are not particular limited, and can be any of blast furnace slag or steel slag, and blast furnace slag is preferable from the viewpoint of reactivity. Particularly, using blast furnace slag fine powder 4000 for concrete in conformity with JIS A 6206 is preferable from the viewpoint of strength development and retractility at ordinary temperature of the geopolymer hardened body produced by using the obtained geopolymer composition.

### Water

As for water, there is no particular limitation, and tap water, ion exchange water, pure water, etc. can be used.

### Carbon Dioxide Gas

It is not necessary that carbon dioxide gas is 100% carbon dioxide gas, and can be gas containing a constant amount of carbon dioxide. Further, by using combustion exhaust gas of cement kiln, bleed gas of chlorine bypass, combustion exhaust gas of a general thermal power station, combustion exhaust gas of incineration system of biomass or biomass power plant, exhaust gas of automobile (concrete mixer truck), etc., carbon dioxide contained in these gases can be immobilized as calcium carbonate, effect of reducing the amount of carbon dioxide emissions can be expected. The carbon dioxide concentration in carbon dioxide gas can be 10 mass % or more, and preferably 50 mass % or more, since the time for carbonation treatment can be shortened. Further, combustion exhaust gas of a general thermal power station is about 15 mass %, and combustion exhaust gas of cement kiln or bleed gas of chloring bypass is 20 mass % to 30 mass %.

### Carbonation Treatment

It is preferable to perform carbonation treatment to slag fine powder, by injecting carbon dioxide gas while mixing uniformly a slurry comprising slag fine powder and water with a stirrer, etc.

As for the slurry comprising slag fine powder and water, it is sufficient to put the slag fine powder and water in a container, mix uniformly with a stirrer, etc. to make the slurry. The amount of water can be the total amount used in the geopolymer composition, or can be a part of it. The mass ratio of water with respect to the slag fine power is preferably 0.4 or more, since the slurry can be easily stirred uniformly. By injecting carbonate gas in a slurry state and perform bubbling, the desired carbonation treatment can be performed in a short time. In the slurry comprising slag fine powder and water, other ingredients generally used for geopolymer composition other than slag powder can be contained within a range that does not affect the effect of the present invention.

The stirrer is not particularly limited as long as it is a known stirring apparatus or knead mixing apparatus used for mixing and kneading mortar or concrete, and for example, hand mixer or Hobart mixer, etc. can be used.

Injection of carbon dioxide gas is performed until the pH of slurry becomes 6.0 to 12.0. In case the pH is less than 6.0, the strength development at ordinary temperature is decreased, and in case the pH is over 12.0, no sufficient working time for construction can be obtained. Therefore, it is preferable that the slurry pH is 6.5 to 7.5, more preferably 6.5 to 7.0, from the point that sufficient working time for construction can be ensured, while maintaining initial strength development of the geopolymer hardened body. The slurry comprising slag fine powder and water before injecting carbon dioxide gas has generally pH 12.5, and the pH decreases when injecting carbon dioxide gas. Further, by injecting carbon dioxide gas, calcium component diluted from slag fine powder in the slurry is captured, changed into inactive calcium carbonate, and carbon dioxide is immobilized. Thus, rapid reaction of alkali metal silicate and calcium component is suppressed, the working time (setting time) can be extended, and a sufficient working time for construction can be obtained.

The slurry temperature when performing carbonation treatment of slag fine powder is preferably 5° C. to 60° C. from the viewpoint of solubility of carbon dioxide to water, or elution of calcium ion from slag fine powder.

When using combustion exhaust gas etc. for carbon dioxide gas, by transporting carbon dioxide gas from gas discharging equipment through pipes, etc., carbonation treatment can be performed not only near the gas discharging equipment, but also at a place separated from the gas discharging equipment. Further, carbon dioxide gas can be injected by introducing a pipe, tube, etc. to the slurry.

The pH can be measured by using a known measuring apparatus, and particularly, it is preferable to use a measuring apparatus for high concentration suspension liquid. The pH measurement can be performed by introducing pH electrodes directly into the slurry. The pH measurement can be continuously performed from the initiation of the treatment, and carbon dioxide gas can be injected until it becomes a predetermined pH. The injection time can be a short time of about 10 to 25 min. by adjusting the carbon dioxide concentration in the carbon dioxide gas used, or the flow rate, and can be easily performed at the construction site.

### Second Step

In the second step of the production method (1), a geopolymer composition is obtained by mixing a slurry containing slag fine powder that has been subjected to a carbonation treatment obtained by the first step, with fly ash and alkali metal salt.

The mixing of a slurry containing slag fine powder that has been subjected to a carbonation treatment obtained by the first step, with fly ash and alkali metal salt can be subsequently performed in the container used for carbonation treatment in the first step, or can be performed by using a different container. By subsequently performing the first step and the second step in the same container, operation can be simplified, and since knead mixing defect can be reduced, it is preferable to subsequently perform the first step and the second step in the same container. In such case, by stirring the slurry containing slag fine powder that has been subjected to a carbonation treatment obtained by the first step, fly ash and alkali metal salt are added and mixed. The order of adding fly ash and alkali metal salt is not limited. The knead mixing apparatus is not particularly limited, and can be the same or different from the first step. For example, bi-axial forced mixer, Hobart mixer, hand mixer, etc. can be exemplified.

In case of performing the first step and the second step in a different container, the order of adding the slurry containing slag fine powder that has been subjected to a carbonation treatment obtained by the first step, fly ash and alkali metal salt in the container in the second step is not limited. However, since mixing can be sufficiently performed, it is preferable to add fly ash and alkali metal salt to the slurry containing slag fine powder that has been subjected to a carbonation treatment obtained by the first step. The order of adding fly ash and alkali metal salt is not limited. The knead mixing apparatus is not particularly limited, and for example, bi-axial forced mixer, Hobart mixer, hand mixer, etc. can be exemplified.

### Fly Ash

Fly ash is a fine ash collected from discharged gas with an ash collector, among coal ash obtained as by-product by calcinating pulverized coal in a boiler of a coal-burning plant, etc. as residual dross of coal combustion. It comprises SiO₂, Al₂O₃ as main components, and is classified into Types I to IV types based on particle size or flow level, in JIS A 6201. The standard of fly ash is not particularly limited, but type I and type II which particle size is fine, and have a rich reactivity are preferable. Further, since free lime contained in fly ash shows a rapid reaction with alkali metal silicate, and can be a factor for the working time (setting time) to shorten, the effect of the present invention is further exerted when using one having a large free lime content. The free lime content of fly ash is generally less than 0.1 mass %, while in the method of the present invention, one having 0.1 mass % or more can be used without problem, one having 0.5 mass % or more can be used without problem, and one having 1.0 mass % or more can be used without problem.

The content rate of fly ash with respect to the total mass of fly ash and slag fine powder is preferably 50 to 90 mass %, and more preferably 60 to 85 mass %. When it is 50 mass % or more, when it is mixed with water to make a geopolymer composition, it is possible to maintain good flowability, and sufficient workability can be easily obtained, and it is also preferable from the viewpoint of expanding efficient use of fly ash. Further, when it is 90 mass % or less, a good strength development of the geopolymer composition hardened body can be obtained in early material age.

### Alkali Metal Salt

Alkali metal salt is a salt comprising alkali metal ion (Li⁺, Na⁺, K⁺, etc.) as constituting ions. Examples of representative alkali metal salts include alkali metal silicate, alkali metal carbonate, etc. Since the heat of dissolution is relatively low, and a geopolymer composition hardened body excellent in compression strength can be obtained by curing at ordinary temperature, without influence on knead mixing step, it is preferable to use alkali metal silicate and alkali metal carbonate in combination. The state of alkali metal salt may be any of liquid and powder, and may be any of anhydrate, hydrate, aqueous solution of the salt. It is preferable to be a powder, since transportability or operability is high.

Here, in a conventional method, it is general to use an aqueous solution of

alkali metal silicate and alkali hydroxide (for example, see paragraph of Patent Literature 1), the transportation to the construction site is difficult in a state of aqueous solution, and even powder (solid) of alkali hydroxide is used, since the heat generated at the time of dissolution into solution is high, it is difficult to perform appropriate knead mixing at the construction site, and it is difficult to ensure the properties of the produced composition. On the other hand, in the method of the present invention, since alkali metal carbonate powder, etc. which heat generation is small is used, knead mixing at the construction site can be easily performed as conventional, and a geopolymer composition can be appropriately produced at the construction site.

### Alkali Metal Silicate

The alkali metal silicate is preferably a powder, since the transportability or operability is high, as stated in the above.

Examples of alkali metal silicate powder include sodium silicate powder (SiO₂/NaO₂ molar ratio: about 1.95 to 3.4), sodium metasilicate powder (Type 1, Type 2), potassium silicate powder, potassium metasilicate powder, and lithium silicate powder, etc. Since it is excellent in strength development or durability, and is a powder material having a relatively low price, sodium silicate powder (SiO₂/NaO₂ molar ratio: about 1.950 to 2.2, H₂O=about 20 mass %) is preferable.

### Alkali Metal Carbonate

The alkali metal carbonate is preferably a powder, since the transportability or operability is high, as stated in the above.

Examples of alkali metal carbonate powder include sodium carbonate powder (Na₂CO₃), potassium carbonate powder (K₂CO₃), lithium carbonate powder (Li₂CO₃), etc. Sodium carbonate powder having a relatively low price, and showing high reactivity to slag fine powder is preferable.

The molar ratio of silicon (Si) constituting the alkali metal salt, contained in alkali metal silicate with respect to alkali metal element (AL) contained in alkali metal salt is preferably 0.05 to 0.85. By setting Si/AL to 0.05 or more, the compression strength of the geopolymer composition hardened body can be ensured even at ordinary temperature, and by setting Si/AL to 0.85 or less, flowability so that the geopolymer composition can be easily used in the fieldwork can be ensured. From the above, it is more preferable that Si/AL is 0.2 to 0.75.

The molar ratio of alkali metal element (AL) constituting the alkali metal salt with respect to water (W) AL/W is preferably 0.05 to 0.3. By setting AL/W to 0.05 or more, the compression strength of the geopolymer hardened body can be ensured even at ordinary temperature, and by setting AL/W to 0.3 or less, flowability so that the geopolymer composition can be easily used in the fieldwork can be ensured. From the above viewpoint, it is more preferable that AL/W is 0.05 to 0.18, and further preferable to be 0.08 to 0.12. Further, alkali metal salt can be added alone, or as aqueous solution. In case of adding alkali metal salt as aqueous solution, the difference of the total water amount contained in the mixture (composition) and the water content in the aqueous solution of alkali metal salt is the water amount used in the first step.

Next, the production method (2) is explained.

Slag fine powder, fly ash, water, carbon dioxide gas and alkali metal salt used in the production method (2) are the same as the slag fine powder, fly ash, water, carbon dioxide gas, and alkali metal salt used in the production method (1).

### First Step

In the first step of production method (2), carbon dioxide gas is injected to a slurry comprising slag fine powder, fly ash and water so that the pH of the slurry becomes 6.0 to 12.0, to perform carbonation treatment to the slag fine powder.

### Carbonation Treatment

The carbonation treatment of the first step in the production method (2) can be similarly performed as the first step of the production method (1), expect that fly ash is added additionally to slag fine powder.

In case fly ash is one having a high calcium content, by adding fly ash additionally to slag fine powder, calcium component diluted from fly ash in the slurry is captured and changed to inactive calcium carbonate, and carbon dioxide can be immobilized. Further, since rapid reaction of calcium component derived from fly ash and alkali metal silicate is suppressed, it is possible to suppress the working time to be shortened because of the calcium component derived from fly ash.

The order of adding each component when preparing a slurry comprising slag fine powder, fly ash and water is not limited.

The content rate of fly ash with respect to the total mass of fly ash and slag fine powder is preferably 50 to 90 mass %, and more preferably 60 to 85 mass %, similarly as the production method (1). When it is 50 mass % or more, when it is a geopolymer composition, it is possible to maintain good flowability, and sufficient workability can be easily obtained, and it is also preferable from the viewpoint of expanding efficient use of fly ash. Further, when it is 90 mass % or less, a good strength development of the geopolymer composition hardened body can be obtained in early material age.

As for the amount of water, similarly as in the production method (1), it can be the total amount used in the geopolymer composition, or can be a part of it. The mass ratio of water with respect to the slag fine power and fly ash is preferably 0.4 or more, since the slurry can be easily stirred uniformly. In the slurry comprising slag fine powder, fly ash and water, other ingredients generally used for geopolymer composition other than slag powder and fly ash can be contained within a range that does not affect the effect of the present invention.

### Second Step

In the second step of the production method (2), a slurry containing slag fine powder that has been subjected to a carbonation treatment obtained by the first step is mixed with alkali metal salt to obtain a geopolymer composition.

The mixing of a slurry containing slag fine powder that has been subjected to a carbonation treatment obtained by the first step, with alkali metal salt can be performed similarly as the second step of the production method (1), expect not adding fly ash, and can be subsequently performed in the container used for carbonation treatment in the first step, or can be performed by using a different container. However, it is preferable to subsequently perform the first step and the second step in the same container.

### Knead Mixing Step

In the production method of a geopolymer composition of the present invention, a knead mixing step of knead mixing a predetermined amount of admixtures, mixture materials, aggregates, etc. at the same time or sequentially after the second step with a knead mixing apparatus is provided. As admixtures or mixture materials, publicly known materials used in concrete, such as a fluidizer, shrinkage reducer, antirust agent, water proof material, setting retarder, antifoam agent, dust reducer, colorant, calcium carbonate powder, etc. can be exemplified. As aggregates, publicly known aggregates used in concrete such as lightweight aggregate, normal aggregate, heavyweight aggregate, limestone aggregate, slag aggregate, silica sand, etc. can be exemplified. The knead mixing apparatus is not particularly limited, and for example, bi-axial forced mixer used for knead mixing concrete, etc. can be exemplified.

By subsequently performing the second step and knead mixing step in the same knead mixing apparatus, operation can be simplified, and knead mixing defect can be reduced. Further, it is possible to subsequently perform from the first step to the knead mixing step in the same knead mixing apparatus. The knead mixing apparatus is not particularly limited, and for example, bi-axial forced mixer, Hobart mixer, hand mixer, etc. can be exemplified.

### Method for Producing a Geopolymer Hardened Body

In the method for producing a geopolymer hardened body of the present invention, in addition to the first step, second step, and knead mixing step which are the method for producing a geopolymer composition, a placing step and curing step are comprised.

The method for producing a geopolymer hardened body of the present invention is a method for producing a geopolymer hardened body comprising, after obtaining a geopolymer composition according to the production method of the present invention described in the above, curing the obtained geopolymer composition at a temperature range of 5° C. to 90° C.

The geopolymer hardened body can be obtained by placing and then curing the geopolymer composition obtained by the above-mentioned production method.

### Placing Step

In the placing step, the geopolymer composition obtained by the method for producing a geopolymer composition of the present invention is put in a mold form. After putting, it is preferable to perform compacting by a known compacting method. Thereby, a consolidated geopolymer hardened body can be obtained.

### Curing Step

By curing the geopolymer composition at a temperature range of 5° C. to 90° C. after the placing step, a geopolymer hardened body which is a hardened body of the geopolymer composition can be obtained. Particularly, when using alkali silicate and alkali carbonate in combination for the geopolymer composition, a geopolymer composition hardened body being excellent in compression strength can be obtained by curing at ordinary temperature of 5 to 35° C. The other curing conditions are not particularly limited, and can be commonly used curing conditions. For example, steam curing, sealed curing, atmospheric curing, water curing, etc. are used.

According to the method for producing a geopolymer composition of the present invention, a geopolymer composition having a strength development and working time sufficient for construction can be obtained in a short time and simply. Further, since the method for producing the geopolymer composition can be performed by using conventional geopolymer materials and known knead mixing apparatus at the construction site, it is not necessary to separately provide equipment for carbonation treatment of slag fine powder. Further, at the time of carbonation treatment of slag fine powder, calcium, magnesium, etc. and carbonate in the slurry of the slag fine powder are formed. Thereby, it has an advantage that immobilization and effective use of CO₂ being a greenhouse effect gas are possible. Further, CO₂ gas used for carbon dioxide can be one comprising a constant amount of CO₂ such as industrial discharged gas. Therefore, the geopolymer hardened body obtained by using the geopolymer composition obtained with the method for producing a geopolymer composition of the present invention has less burden on environment than a conventional geopolymer composition, and can be used for various applications as a bonding material of concrete, in place of cement composition.

### Other Embodiments

The method for producing a geopolymer composition, and the method for producing a geopolymer hardened body of the present invention shall not be limited to the above embodiments, and various changes can be added as long as it does not go beyond the gist of the present invention. Further, a part of the constitution of a certain embodiment can be deleted. Furthermore, a known technique can be added to a constitution of a certain embodiment.

### EXAMPLES

In the following, the present invention will be explained in further details, by referring to specific examples. However, the present invention is not limited to the following examples. Unless the features of the present invention are not largely impaired, various deformed examples or applications are also encompassed in the present invention.

### Raw Material

(1) fly ash (FA): Type II fly ash (in conformity to JIS A 6201, free line about 0.1 mass %)
(2) slag fine powder (BFS); furnace slag fine powder 4000 (in conformity to JIS A 6206)

### Alkali Metal Salt (Alkali Metal Silicate Powder, Alkali Metal Carbonate Powder)

(3) powder sodium silicate: sodium silicate powder (SiO₂/Na₂O molar ratio=1.98, H₂O=about 20 mass %, manufactured by Tokuyama)
(4) soda ash: sodium carbonate powder (manufactured by Tokuyama)

### Other Raw Materials

(5) aggregates: fine aggregates (JIS standard sand)
(6) water: ion exchange water

### Comparative Example 1

Comparative Example 1 is a geopolymer composition prepared by a production method that does not comprise a carbonation treatment step of slag fine powder. Fly ash, slag fine powder, soda ash, and powder sodium silicate were weighed according to the recipe of Table 1, put in a polyethylene bag and stirred for 3 min to prepare a powdered-state geopolymer composition having an uniform dispersion state. The powdered-state geopolymer composition and water were put in a Hobart mixer, stirred for 1 minute. Then 1512.4 g of aggregates were put, knead mix for 30 sec., and by scraping off for 15 sec., the mixture was further kneaded and mixed for 2 min. to obtain a geopolymer composition knead mixed uniformly as a mortar.

### Examples 1 to 5

Examples 1 to 5 are a geopolymer composition prepared by a production method comprising a carbonation treatment step of slag fine powder. The recipe of fly ash, slag fine powder, soda ash and powder sodium silicate is shown in Table 1.

In Examples 1 to 4, as first step, in a Hobart mixer (manufactured by Hobart Japan, Ltd.: Type: Mixer N5), carbon dioxide gas (100%) was injected to a slurry comprising slag fine powder and water (total amount of mixture) using a silicon tube (inner Ø 6 mm) from a carbon dioxide gas cylinder, until the slurry has a predetermined pH. The pH of slag fine powder during carbonation treatment was continuously confirmed by using glass pH electrode (AS ONE CORPORATION; Type: AS800). The conditions of carbonation treatment are shown in Table 2. As second step, to the Hobart mixer containing the slag fine powder slurry that has been subjected to carbonation treatment used in the first step, fly ash and alkali metal salt were added, stirred for 1 min. Then, 1512.4 g of aggregates were put, knead mix for 30 sec., and by scraping off for 15 sec., the mixture was further kneaded and mixed for 2 min. to obtain a geopolymer composition knead mixed uniformly as a mortar.

In Example 5, operation was performed similarly as Example 4 except of using a slurry comprising fly ash, slag fine powder and water (total amount of mixture) in the first step.

Content of various slag fine powder, AL/W (molar ratio), Si/Al (molar ratio) and (AL+W)/P contributing to the working time, compression strength and 15-stroke mortar flow value (flowability) were in conformity with Comparative Example 1.

TABLE 1

| | | | AL(alkali source) | | | | | | |
|---|---|---|---|---|---|---|---|---|---|
| | | | | powder | | | | | |
| | P(active filler) | | | sodium | W | sand | (AL + W)/P | AL/W | Si/AL |
| | FA | BFS | soda ash | silicate | water | amount | (volume | (molar | (molar |
| | (g) | (g) | (g) | (g) | (g) | (g) | ratio) | ratio) | ratio) |
| Comparative | 339.7 | 110.3 | 17.5 | 92.6 | 186.9 | 1512.4 | 1.17 | 0.103 | 0.708 |
| Example 1 | | | | | | | | | |
| Example 1 | | | | | | | | | |
| Example 2 | | | | | | | | | |
| Example 3 | | | | | | | | | |
| Example 4 | | | | | | | | | |
| Example 5 | | | | | | | | | |

* AL/W: molar ratio of alkali metal element (AL) contained in soda ash, powder sodium silicate to water (W)
* Si/AL: molar ratio of silicon (Si) contained in soda ash, powder sodium silicate to alkali metal element (AL)
* (AL + W)/P: volume ratio of the solution in which soda ash, powder sodium silicate are mixed with water, with respect to fly ash, slag fine powder

### Measurement of Working Time

At present time, the method for measuring working time is not established. For the normal Portland cement (JIS R5210) with a composition in conformity to JIS R 5201 (11.5.1 mortar mixed), 15-stroke mortar flow test described in JIS R 5201 was performed every 5 min. immediately after knead mixing to 30 min., and every 10 min. after 30 min., it became less than 130 mm after 120 min, and this was used as standard of determining whether or not it is usable. Therefore, by performing mortar flow test every 5 min. immediately after knead mixing to 30 min., and every 10 min. after 30 min., and the time elapsed to the time point where the flow value became less than 130 mm has been determined to be the working time of the geopolymer composition. The results are shown in Table 2.

### Compressive Strength Test

The mortar of Comparative Example 1 and Examples 1 to 5 were enclosed in a container having Ø (diameter) of 50 mm×100 mm, and seal curing was performed at 20° C., 95% RH, until a predetermined material age (day 1, day 7, and day 28).

Mortar that has been cured until a predetermined material age (day 1, day 7, and day 28) has been subjected to compressive strength test in conformity to Compressive strength test method described in JIS A 1108 to measure compressive strength. The results are shown in Table 2. The values shown in parenthesis are the compressive strength ratio as compared to Comparative Example 1.

TABLE 2

| | First step | | | | | | | | | |
|---|---|---|---|---|---|---|---|---|---|---|
| | (carbonation treatment) | | | working | Compression strength (N/mm2) | | | | | |
| | CO2 amount | pH (after | time | time | | | | | | |
| | (L/min) | treatment) | (min) | (min) | day 1 | | day 7 | | day 28 | |
| Comparative Example 1 | — | 12.2 | — | 15 | 10.3 | (100) | 36.8 | (100) | 54 | (100) |
| Example 1 | 5 | 9.1 | 2.5 | 25 | 8.61 | (84) | 34.6 | (94) | 50.9 | (94) |
| Example 2 | 5 | 8.1 | 5 | 50 | 9.12 | (89) | 34.3 | (93) | 50.6 | (94) |
| Example 3 | 5 | 7.0 | 10 | 70 | 9.22 | (90) | 34.9 | (95) | 52 | (96) |
| Example 4 | 5 | 6.6 | 25 | 100 | 8.56 | (83) | 33.4 | (91) | 49.7 | (92) |
| Example 5 | 5 | 6.8 | 25 | 100 | 8.62 | (84) | 33.7 | (92) | 50.3 | (93) |

As shown in Table 2, in Comparative Example 1, the working time is 15 min. and working time sufficient for construction at a construction site cannot be obtained.

In Examples 1 to 5, as compared to Comparative Example 1, the working time has been largely extended. Particularly, in Examples 3 to 5, a working time of 1 hour or more that can sufficiently ensure the operation time at the actual site was obtained, and the strength development is 80% or more as compared with the system using non-treated slag fine powder.

1. A method for producing a geopolymer composition comprising slag fine powder, fly ash and alkali metal salt, the method comprising the following treatment (1) or (2):
(1) injecting carbon dioxide gas to a slurry comprising slag fine powder and water so that the pH of the slurry becomes 6.0 to 12.0, to perform carbonation treatment to the slag fine powder, and mixing the slurry comprising the slag fine powder which has been subjected to carbonation treatment with fly ash and alkali metal salt; or
(2) injecting carbon dioxide gas to a slurry comprising slag fine powder, fly ash and water so that the pH of the slurry becomes 6.0 to 12.0, to perform carbonation treatment to the slag fine powder, and mixing the slurry comprising the slag fine powder which has been subjected to carbonation treatment with alkali metal salt.

2. The method for producing a geopolymer composition according to claim 1, wherein the pH of the slurry in the carbonation treatment is 6.5 to 7.5.

3. A method for producing a geopolymer hardened body, comprising, after obtaining a geopolymer composition by to the method according to claim 1, curing the obtained geopolymer composition within a temperature range of 5° C. to 90° C.

4. The method for producing a geopolymer hardened body according to claim 3, comprising curing the geopolymer composition within a temperature range of 5° C. to 35° C.

5. The method for producing a geopolymer composition according to claim 1, wherein the alkali metal salt comprises alkali metal silicate powder and alkali metal carbonate powder.

6. The method for producing a geopolymer composition according to claim 5, wherein the alkali metal silicate powder is a sodium silicate powder.

7. The method for producing a geopolymer composition according to claim 5, wherein the alkali metal carbonate powder is a sodium carbonate powder. 8 (Original) The method for producing a geopolymer composition according to claim 5, wherein the alkali metal silicate powder is a sodium silicate powder and the alkali metal carbonate powder is a sodium carbonate powder.

9. The method for producing a geopolymer composition according to claim 5, wherein the treatment of (1) and (2) is performed at a construction site to harden a geopolymer composition.
